(19) United States
(12) Patent Application Publication
(10) Pub. No.: US 2011/0070511 A1
(43) Pub. Date: Mar. 24, 2011

(54) COOLING SUBSYSTEM FOR AN ELECTROCHEMICAL FUEL CELL SYSTEM

(75) Inventors: Amy E. Nelson, Vancouver (CA); Bruce Lin, Vancouver (CA); Joy A. Roberts, Coquitlam (CA); Uwe M. Limbeck, Kirchheim unter Teck (DE); Craig R. Louie, West Vancouver (CA); Peter J. Bach, Vancouver (CA)

(73) Assignees: DAIMLER AG, Stuttgart (DE); FORD MOTOR COMPANY, Dearborn, MI (US)

(21) Appl. No.: 12/956,226

(22) Filed: Nov. 30, 2010

Related U.S. Application Data
(62) Division of application No. 10/936,461, filed on Sep. 8, 2004.
(60) Provisional application No. 60/560,731, filed on Feb. 9, 2004.

(51) Int. Cl. H01M 8/04

(52) U.S. Cl. 429/429

(57) ABSTRACT

Improvements in startup time for an electrochemical fuel cell system from freezing and sub-freezing temperatures may be observed by minimizing the coolant volume in the coolant subsystem. In particular, this may be accomplished by having a two pump—dual loop cooling subsystem. During startup, one pump directs coolant through a startup coolant loop and after either the fuel cell stack or the coolant temperature reaches a predetermined threshold value, coolant from a main or standard coolant loop is then directed to the fuel cell stack. In an embodiment, coolant from the standard loop mixes with coolant in the startup loop after the predetermined threshold temperature is reached.

### BACKGROUND OF THE INVENTION

1. Field of the Invention

The present invention relates to electrochemical fuel cells and more particularly to subsystems and methods for controlling the temperature of a fuel cell system during startup.

2. Description of the Related Art

Electrochemical fuel cells convert reactants, namely fuel and oxidant fluid streams, to generate electric power and reaction products. Electrochemical fuel cells employ an electrolyte disposed between two electrodes, namely a cathode and an anode. The electrodes each comprise an electrocatalyst disposed at the interface between the electrolyte and the electrodes to induce the desired electrochemical reactions. The location of the electrocatalyst generally defines the electrochemically active area.

Polymer electrolyte membrane (PEM) fuel cells generally employ a membrane electrode assembly (MEA) consisting of an ion-exchange membrane disposed between two electrode layers comprising porous, electrically conductive sheet material as fluid diffusion layers, such as carbon fiber paper or carbon cloth. In a typical MEA, the electrode layers provide structural support to the ion-exchange membrane, which is typically thin and flexible. The membrane is ion conductive (typically proton conductive), and also acts as a barrier for isolating the reactant streams from each other. Another function of the membrane is to act as an electrical insulator between the two electrode layers. The electrodes should be electrically insulated from each other to prevent short-circuiting. A typical commercial PEM is a sulfonated perfluorocarbon membrane sold by E.I. Du Pont de Nemours and Company under the trade designation NAFION®.

The MEA contains an electrocatalyst, typically comprising finely comminuted platinum particles disposed in a layer at each membrane/electrode layer interface, to induce the desired electrochemical reaction. The electrodes are electrically coupled to provide a path for conducting electrons between the electrodes through an external load.

In a fuel cell stack, the MEA is typically interposed between two separator plates that are substantially impermeable to the reactant fluid streams. The plates act as current collectors and provide support for the electrodes. To control the distribution of the reactant fluid streams to the electrochemically active area, the surfaces of the plates that face the MEA may have open-faced channels formed therein. Such channels define a flow field area that generally corresponds to the adjacent electrochemically active area. Such separator plates, which have reactant channels formed therein are commonly known as flow field plates. In a. fuel cell stack a plurality of fuel cells are connected together, typically in series, to increase the overall output power of the assembly. In such an arrangement, one side of a given plate may serve as an anode plate for one cell and the other side of the plate may serve as the cathode plate for the adjacent cell. In this arrangement, the plates may be referred to as bipolar plates.

The fuel fluid stream that is supplied to the anode typically comprises hydrogen. For example, the fuel fluid stream may be a gas such as substantially pure hydrogen or a reformate stream containing hydrogen. Alternatively, a liquid fuel stream such as aqueous methanol may be used. The oxidant fluid stream, which is supplied to the cathode, typically comprises oxygen, such as substantially pure oxygen, or a dilute oxygen stream such as air. In a fuel cell stack, the reactant streams are typically supplied and exhausted by respective supply and exhaust manifolds. Manifold ports are provided to fluidly connect the manifolds to the flow field area and electrodes. Manifolds and corresponding ports may also be provided for circulating a coolant fluid through interior passages within the stack to absorb heat generated by the exothermic fuel cell reactions. The preferred operating temperature range for PEM fuel cells is typically 50° C. to 120° C., most typically between 75° C. and 85° C.

Under typical conditions, start-up of the electrochemical fuel cell stack is under high ambient temperatures and the fuel cell stack can be started in a reasonable amount of time and quickly brought to the preferred operating temperature. In some fuel cell applications, it may be necessary or desirable to commence operation of an electrochemical fuel cell stack when the stack core temperature is below the freezing temperature of water and even at subfreezing temperatures below −25° C. However, at such low temperatures, the fuel cell stack does not operate well and rapid start-up of the fuel cell stack is more difficult. It may thus take a considerable amount of time and/or energy to take an electrochemical fuel cell stack from a cold starting temperature below the freezing temperature of water to efficient operation.

In U.S. Pat. No. 6,358,638, a method of heating a cold MEA to accelerate cold start-up of a PEM fuel cell is disclosed. In the '638 patent, either fuel is introduced into the oxidant stream or oxidant is introduced into the fuel stream. The presence of platinum catalyst on the electrodes promotes an exothermic chemical reaction between hydrogen and oxygen which locally heats the ion-exchange membrane from below freezing to a suitable operating temperature. However, there remains a need in the art for more efficient methods of efficiently starting a fuel cell stack at low and sub-freezing temperatures. The present invention fulfills this need and provides further related advantages.

### BRIEF SUMMARY OF THE INVENTION

Significant improvements in start-up time from freezing or sub-freezing temperatures can be achieved by using a two pump—dual loop cooling subsystem. For example, in an electrochemical fuel cell system, the cooling subsystem may comprise both a startup coolant loop comprising a startup pump fluidly connected to the electrochemical fuel cell stack; and a standard coolant loop comprising a standard pump and a stack valve. The coolant volume of the startup coolant loop is less than the coolant volume in the standard coolant loop. During start-up, the stack valve is closed such that the electrochemical fuel cell stack is fluidly isolated from the standard coolant loop. Coolant in the startup loop circulates through the fuel cell stack and helps to quickly bring the temperature of the stack to desired temperature. If coolant did not flow through the stack, localized heating within the stack could detrimentally affect the stack. By minimizing the coolant volume in the startup loop, and in particular, by having a smaller coolant volume than in the standard coolant loop, more efficient heating can occur.

In an alternate embodiment, a cooling subsystem for an electrochemical fuel cell system may comprise a startup coolant loop fluidly connected to the electrochemical fuel cell. The startup coolant loop comprises a startup pump. The cooling subsystem also comprises a standard coolant loop comprising a standard pump and a stack valve. When the stack valve is closed, only the startup coolant loop is fluidly connected to the electrochemical fuel cell stack. However, when the stack valve is open, both the startup coolant loop and the standard coolant loop are fluidly connected to the fuel cell stack. Thus, a smaller coolant volume is available to the fuel cell stack during start-up when efficient heating is needed and a larger coolant volume is available during normal operation from both coolant loops. In a preferred embodiment, the startup coolant loop is also fluidly connected to the standard coolant loop when the stack valve is open. This is simpler to manufacture and allows the coolants to mix, thereby reducing thermal shock when the colder coolant from the standard coolant loop flows to the fuel cell stack. Nevertheless, both coolant loops could remain fluidly isolated throughout.

A method for operating the coolant subsystem for an electrochemical fuel cell system during startup comprises: (a) directing a first coolant through a fuel cell stack; and (b) directing a second coolant through the fuel cell stack when the temperature of either the fuel cell stack or the first coolant reaches a first predetermined temperature. The first coolant is fluidly isolated from the second coolant during the initial step (a). When the temperature of either the fuel cell stack or the coolant in the startup loop has reached the predetermined threshold value, the stack valve may be opened such that the electrochemical fuel cell stack becomes fluidly connected to the standard coolant loop and thereby allow additional cooling of the fuel cell stack. In an embodiment, coolant from the standard coolant loop mixes with the coolant in the startup loop when the stack valve opens.

In an embodiment, the first predetermined temperature is the desired operating temperature of the fuel cell system, for example, 60 to 80° C. In another embodiment, the predetermined temperature is less than the desired operating temperature, for example less than 60° C., more particularly less than 50° C. Typically such a predetermined temperature would be greater than 30° C. or greater than 40° C.

The startup loop may further comprise a heater to help quickly bring the temperature of the coolant up to desired temperature. To further minimize the coolant volume in the startup coolant loop, the loop may be integrated into the stack manifold. Other components in the coolant subsystem may include a compressor, a cathode feed heat exchanger, or a radiator. If the fuel cell system is used in a motor vehicle, the coolant subsystem may further comprise a propulsion system and/or a car heating system.

These and other aspects of the invention will be evident upon reference to the attached figures and following detailed description.

### BRIEF DESCRIPTION OF THE DRAWINGS

FIG. 1 is a schematic of a prior art coolant subsystem for an electrochemical fuel cell system.

FIG. 2 is a schematic of an embodiment of a coolant subsystem for an electrochemical fuel cell system.

FIG. 3 is a schematic of an embodiment of a coolant subsystem for an electrochemical fuel cell system.

FIG. 4 is a schematic of a coolant subsystem testing chamber for an embodiment of the present invention.

FIG. 5 is a graph of coolant temperature as a function of time for three different fuel cell systems using the coolant subsystem testing chamber of FIG. 4.

FIG. 6 is a graph of power achieved for a fuel cell system as a function of time for three different fuel cell systems using the coolant subsystem testing chamber of FIG. 4.

In the above figures, similar references are used in different figures to refer to similar elements.

### DETAILED DESCRIPTION OF THE INVENTION

Temperature regulation of a fuel cell system is typically performed with a coolant circulated throughout a coolant subsystem. Common coolants include, for example, water, ethylene glycol, propylene glycol, fluoroinerts, alcohols or a combination thereof. Choice of coolant is dictated in part, by the physical conditions the fuel cell is expected to be subjected to. For example, if the fuel cell stack will be operated in freezing or sub-freezing temperatures, a coolant would likely be chosen such that it did not freeze under such conditions. The primary purpose of a coolant is to regulate temperature and prevent over-heating of the fuel cell stack, as well as other components in the fuel cell system such as, for example, the compressor, cathode feed, propulsion system, car heating, motors, electronics, etc. During startup, and particularly when the fuel cell stack is subjected to freezing or sub-freezing temperatures, the coolant can also assist in bringing the fuel cell stack to its optimal operating temperature.

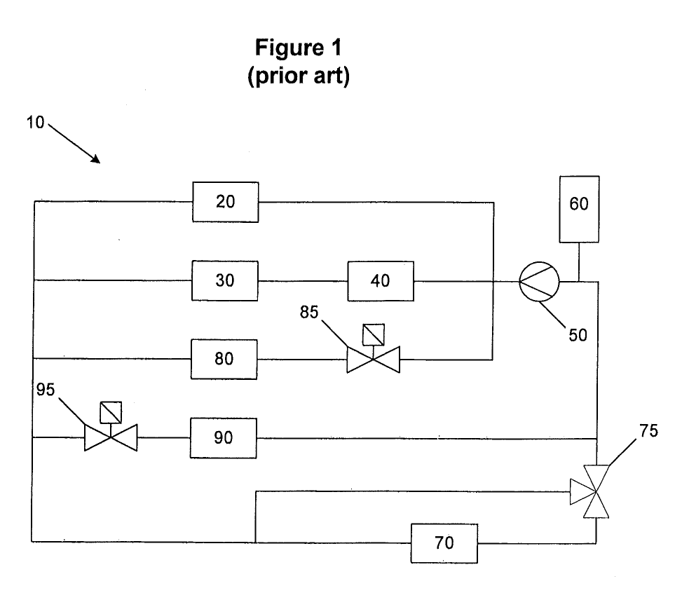

FIG. 1 is a schematic of a conventional coolant subsystem 10 for an electrochemical fuel cell system. Coolant subsystem 10 may comprise a pump 50 fluidly connected to a fuel cell stack 20, a compressor 30, a cathode feed heat exchanger 40 and a coolant reservoir 60. Coolant from coolant reservoir 60 can then be circulated through fuel cell stack 20, compressor 30 and cathode feed heat exchanger 40 to assist with temperature regulation of these components. In particular, with respect to compressor 30, temperature regulation of the compressor motor and the compressor inverter (not shown) may be desired, either individually or together. Temperature sensors (not shown) may measure the temperature of fuel cell stack 20 and/or the temperature of the coolant circulating through coolant subsystem 10. The coolant subsystem 10 may also comprise a radiator 70 and a radiator valve 75. Once the temperature of fuel cell stack 20 or the coolant exceeds a certain predetermined threshold, radiator valve 75 may direct the circulating coolant through radiator 70 to achieve additional cooling of the fuel cell system.

Other components may also be coupled to coolant subsystem 10 as needed, particularly as used in automotive applications. For example, a propulsion system 80 may be reversibly fluidly connected to coolant subsystem 10 by a propulsion valve 85. Similarly, a car heating system 95 may be reversibly fluidly connected to coolant subsystem 10 by a car heating valve 95. Thus the same coolant subsystem 10 used to regulate the temperature of fuel cell stack 20 may be used to regulate the temperature of a number of other components as needed.

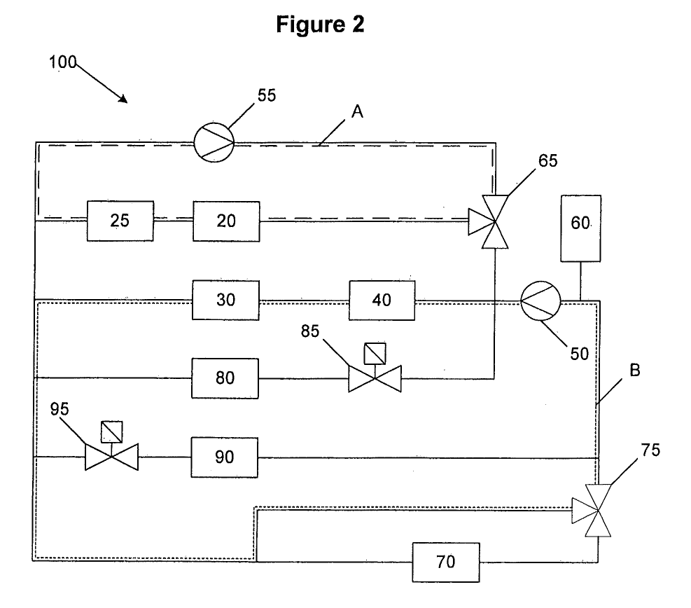

FIG. 2 is a schematic of an embodiment of a coolant subsystem 100. Pump 50 may circulate a coolant from coolant reservoir 60 through components of the fuel cell system such as compressor 30, cathode feed heat exchanger 40 and reversibly through other components such as radiator 70, propulsion system 80 and car heating system 90 as in the coolant subsystem illustrated in FIG. 1. This is illustrated in FIG. 2 as standard coolant loop B. Coolant subsystem 100 additionally comprises a second start-up coolant loop A which may be reversibly fluidly isolated from standard coolant loop B by a stack valve 65. Stack valve 65 may be, for example, a thermostatic valve or a proportional valve. In particular, start-up coolant loop A may comprise fuel cell stack 20, a pump 55 and an optional heater 25. During start-up of the fuel cell system, particularly when the system is subjected to freezing or sub-freezing temperatures, stack valve 65 may be closed such that coolant loop A and coolant loop B are fluidly isolated. During start-up procedures, coolant in both coolant loop A and in coolant loop B would increase in temperature. The relatively small volume of coolant in coolant loop A allows quick and efficient heating, particularly in comparison to coolant in coolant loop B. This may reduce the amount of time needed to bring fuel cell stack 20 to an appropriate temperature at which fuel cell stack 20 may be started. In fact, with a reduced volume in coolant loop A, no preheating may be necessary in some embodiments and fuel cell stack 20 may self start at the freezing temperature. Typically, an appropriate temperature at which power can be pulled from fuel cell stack 20 would be at about 5° C. In other embodiments, heater 25 may also be used to heat coolant in coolant loop A and assist with bringing fuel cell stack 20 to this temperature.

At very cold temperatures, the viscosity of coolant in coolant loop A may be much higher than at warmer temperatures. This increased viscosity may affect the coolant flow rate and care should be taken that pump 55 maintains a sufficient coolant flow rate in coolant loop A. Otherwise localized heating may occur in fuel cell stack 20 leading to damage to individual cells from local overtemperature. However, when at freezing and sub-freezing temperatures, less heat is generated by fuel cell stack 20 and the individual fuel cells in stack 20 may absorb a significant amount of the heat that is generated so even with the increased viscosity, the coolant flow rate can be significantly less than that required at normal operating conditions. The flow rate is strongly dependent on stack design and materials and on the amount of heat generation in fuel cell stack 20 and can be easily determined by a person of ordinary skill in the art. Nevertheless, the coolant flow rate in coolant loop A during cold-start phase for a typical automotive fuel cell system can be as low as 5 to 25 slpm (standard liters per minute), more particularly 15 to 25 slpm for an 85 kW gross fuel cell stack and still meet cell cooling requirements with no local hot spots.

As fuel cell stack 20 heats up and coolant in coolant loop A similarly heats up, the viscosity drops and, depending on pump design (for example positive displacement or mixed flow), the flow rate will naturally increase. This natural increase in coolant flow rate may be sufficient in some fuel cell systems to meet the increased cooling requirements of fuel cell stack 20 during start-up. Thus, a low cost fixed speed pump may be all that is necessary in coolant loop A for pump 55. In comparison, pump 50 in coolant loop B may still have speed control to adjust flow rate of coolant during normal operation. Furthermore, during normal operation, pump 55 may be used to augment coolant flow through fuel cell stack 20 resulting in a smaller pump 50 than typically needed in a conventional cooling subsystem.

As coolant in coolant loop A heats up, it may expand and an expansion reservoir in coolant loop A (not shown) may be used to accommodate the increased coolant volume. In the embodiment illustrated in FIG. 2, such an expansion reservoir may not be necessary as any excess volume may directly leak into coolant loop B as only one valve, namely stack valve 65 separates coolant loop A from coolant loop B. In any event, the pressure increase in coolant loop A due to the increased coolant volume would be expected to be minimal.

Heater 25 may also be used to heat coolant in coolant loop A and assist with bringing fuel cell stack 20 to an operating temperature. A heater may also be used in conventional coolant designs or in coolant loop B (not shown). While heater 25 may be useful in some fuel cell systems, some heaters may not have the necessary heat flux to compensate for the increased thermal mass of the coolant needed to accommodate the heater itself.

The thermal mass of the coolant in coolant loop A may be minimized further by integration of coolant loop A into the fuel cell stack manifold (not shown).

When the temperature of either the coolant in coolant loop A or fuel cell stack 20 has reached a threshold temperature, stack valve 65 may open to begin letting coolant from coolant loop B in to fuel cell stack 20. This threshold temperature, may be, for example, between 30 and 80° C. In an embodiment, the threshold temperature is between 60 and 80° C., i.e., the normal operating temperature of fuel cell stack 20. In this embodiment, fuel cell stack 20 reaches its desired operating temperature in the minimum amount of time, allowing greater power density to be drawn from fuel cell stack 20 at an earlier time. In another embodiment, the threshold temperature is at a temperature below 60° C., more particularly below 50° C. As cooler coolant from coolant loop B is introduced into warmer coolant in coolant loop A, a temperature gradient may develop. At lower temperatures, a fuel cell stack 20 can typically be subjected to higher temperature gradients without any adverse effects (for example, temperature gradients up to 30° C.). However, at 60 to 80° C., typical fuel cell stacks 20 can only safely be subjected to smaller temperature gradients, for example, less than 10° C. Accordingly, by having a lower threshold temperature (i.e., 30-60° C. instead of 60-80° C.) for letting coolant from coolant loop B into fuel cell stack 20, there is a reduced risk of damaging fuel cell stack 20 from thermal shock. Regardless of the threshold temperature, care should be taken to reduce the risk of thermal shock. This may be done, for example, by controlling the rate at which coolant from coolant loop B is introduced into coolant loop A.

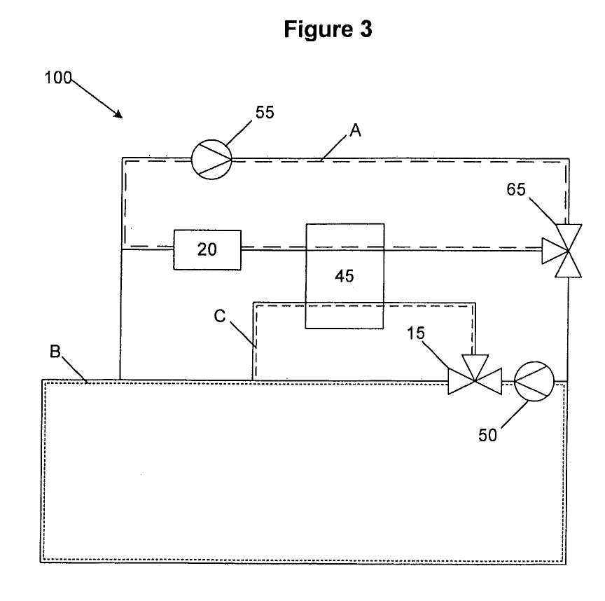

In a further embodiment illustrated in FIG. 3, the risk of subjecting the fuel cell stack 20 to thermal shock can be reduced or even eliminated by the use of a heat exchanger 45 instead of a thermostatic valve as stack valve 65. Coolant loops A and B are configured as in FIG. 2 and as such, many of the components of the loops have not been explicitly illustrated in FIG. 3. In the embodiment illustrated in FIG. 3, coolant from coolant loop B may be directed to a coolant loop C by a valve 15. Coolant loop C contains heat exchanger 45 in thermal contact with coolant loop A. In particular, during initial startup conditions, valve 15 would be closed and as such coolant only circulates in coolant loops A and B but not in coolant loop C. Coolant temperature would increase in both coolant loops A and B though typically, the temperature would increase faster in coolant loop A than in coolant loop B. When either fuel cell stack 20 or coolant in coolant loop A reaches a first predetermined threshold; valve 15 would then open allowing coolant from coolant loop B to circulate into coolant loop C and back thereby further increasing the temperature of coolant in coolant loop B. Once the coolant in coolant loop B reaches a second predetermined threshold, stack valve 65 may then open. Another way of considering this operation is that once the difference in temperature between the coolant in coolant loop A and coolant loop B is below some predetermined thermal shock value then stack valve 65 may open allowing coolant B to mix with coolant A. As there is thus a relatively small difference in temperature between coolant in coolant loop A and coolant in coolant loop B, the risk of subjecting fuel cell stack 20 to thermal shock is reduced or eliminated.

The additional precautions as shown in FIG. 3 may not be necessary to avoid thermal shock in the embodiment illustrated in FIG. 2. When coolant loop A reaches a desired operation temperature, stack valve 65 may only open enough to maintain the operating temperature of fuel cell stack 20. As coolant from coolant loop B is slowly mixed in with coolant from coolant loop A, fuel cell stack 20 is maintained at the mixing temperature and coolant in coolant loop B continues to increase in temperature. Once the temperature of coolant in both coolant loops A and B are at the same temperature, stack valve 65 may be completely opened. Radiator valve 75 may also be opened to maintain the cooling subsystem at the desired operating temperature. Thus it may be possible to avoid thermal shock without resorting to additional coolant loops.

### EXAMPLES

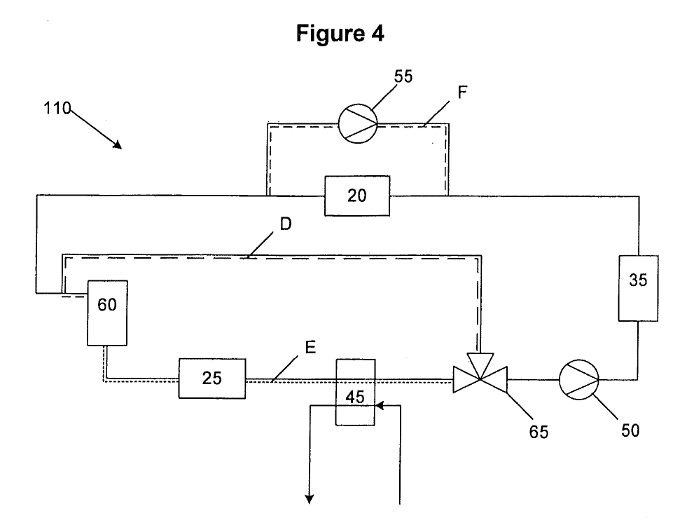

A test chamber was constructed as illustrated in FIG. 4 to illustrate the effect of reduced coolant volumes on efficiency and time to bring fuel cell systems from freezing and subfreezing temperatures to normal operating temperatures. Three coolant paths were constructed, namely coolant path D, coolant path E and coolant path F. A pump 50 pumped coolant through a flow meter 35 and fuel cell stack 20 through coolant paths D and E. Coolant path E further comprises coolant reservoir 60, heater 25, and heat exchanger 45. A chilled coolant from station was directed through heat exchanger 45 as illustrated by black arrows. Coolant path E is illustrative of a conventional fuel cell system and coolant path D represents a reduced coolant volume obtained by bypassing nonessential components in a fuel cell stack though still using a one-pump system. A separate coolant path F having a stack pinup 55 was used to compare the effect of a two pump system and an even smaller coolant volume during start-up.

Three different volumes of coolant were tested: standard coolant volume (5000 mL) for coolant path E, small coolant volume (1000 mL) for coolant path D and micro coolant volume (100 mL) for coolant path F.

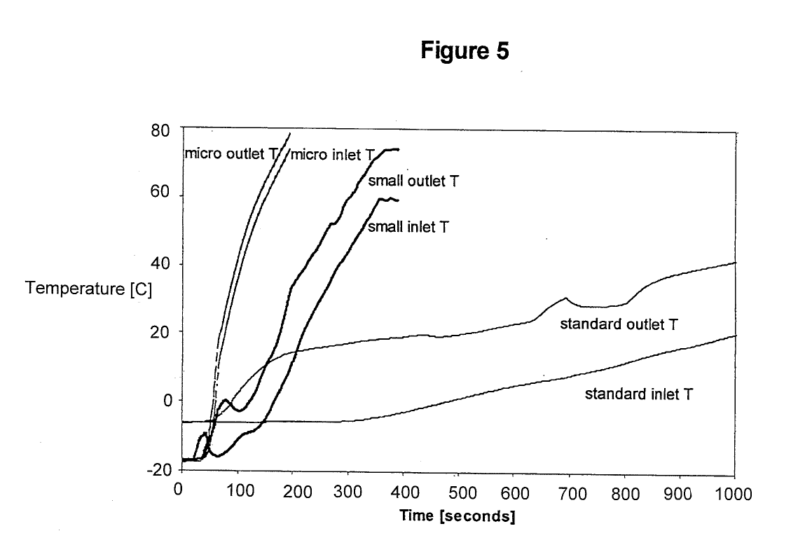

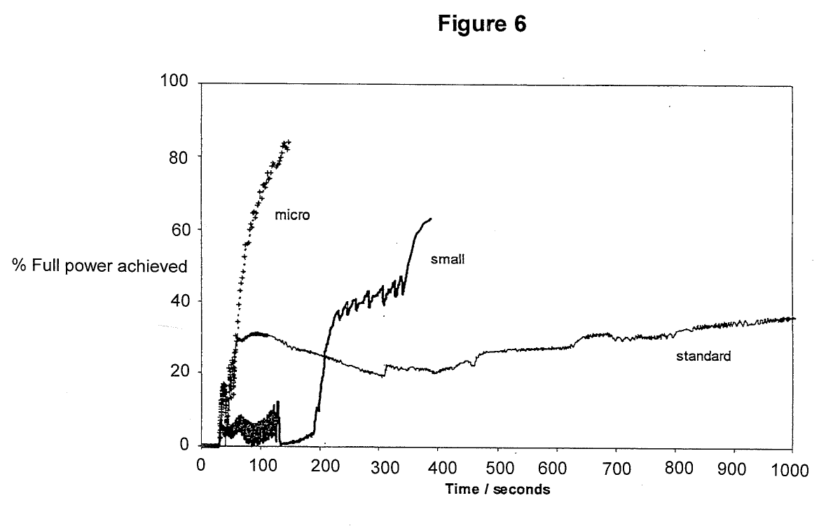

FIG. 5 is a graph of coolant temperature as a function of time for the three different coolant volumes using the coolant subsystem testing chamber of FIG. 4. Temperature sensors (not shown in FIG. 4) were located at the coolant inlet and coolant outlet of fuel cell stack 20. The starting temperatures for the trials were at −5° C. for the standard coolant volume and −15° C. for the small and micro coolant volumes. As seen from FIG. 5, the coolant volume has a significant effect on the length of time needed to bring the fuel cell system to its operating temperatures. Even after 16 minutes, the standard coolant volume had only increased in temperature to between 20 and 40° C. In comparison, the small coolant volume had increased in temperature to between 60 and 75° C. in only 6 and it only took 3 minutes for the micro coolant volume to increase in temperature to between 75 and 80° C. This increase in temperature has a significant effect on the amount of power that can be generated by fuel cell stack 20 as shown in FIG. 6.

FIG. 6 shows a graph of power achieved for a fuel cell system as a function of time. Specifically, FIG. 6 shows the percentage of full power generated by fuel cell stack 20 as a function of time. After 16 minutes, fuel cell stack 20 operating with a standard coolant volume was only able to generate approximately 35% of its full power. In comparison, it took only 6.5 minutes for fuel cell stack 20 to generate over 60% of its full power when small coolant volume was used and only 2 minutes for fuel cell stack 20 to generate over 80% of its full power when the micro coolant volume was used. The magnitude of this effect is significant as it is approximately a magnitude of time faster.

While the above embodiments have been described with respect to automotive fuel cell applications, it is understood that the above embodiments could be adapted for any fuel cell application and in particular, any power generation applications where the unit is located outside or otherwise subjected to freezing or sub-freezing temperatures.

From the foregoing, it will be appreciated that, although specific embodiments of the invention have been described herein for purposes of illustration, various modifications may be made without deviating from the spirit and scope, of the invention. Accordingly, the invention is not limited except as by the appended claims. All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

1-20. (canceled)

21. A method for operating a coolant subsystem for an electrochemical fuel cell system during startup, wherein the temperature of the fuel cell stack prior to startup is below 0° C., the method comprising:
(a) directing coolant from a startup coolant loop through a fuel cell stack, the fuel cell stack having a temperature prior to startup of below 0° C.; and
(b) directing coolant from a standard coolant loop through the fuel cell stack when the temperature of either the electrochemical fuel cell stack or the coolant in the startup coolant loop reaches a first predetermined temperature;
wherein the standard coolant loop is fluidly isolated from the fuel cell stack while the startup coolant loop is directed through the fuel cell stack.

22. The method of claim 21 wherein the coolant volume of the startup coolant loop is less than the coolant volume of the second standard coolant loop.

23. The method of claim 21 wherein the coolant from the startup coolant loop and the standard coolant loop mix in step (b).

24. (canceled)

25. The method of claim 21 wherein the temperature of the fuel cell stack prior to startup is below −25° C.

26. The method of claim 21 wherein the first predetermined temperature is between 30 and 60° C.

27. The method of claim 21 wherein the first predetermined temperature is less than 50° C.

28. The method of claim 21 wherein the first predetermined temperature is between 60 and 80° C.

29. The method of claim 21 further comprising directing coolant from the standard coolant loop through a radiator when coolant from the standard coolant loop reaches a second predetermined temperature.

30. The method of claim 29 wherein the second predetermined temperature is the desired operating temperature of the fuel cell stack.

31. The method of claim 29 wherein the second predetermined temperature is between 60 and 80° C.

32. A method for starting up an electrochemical fuel cell system from a startup temperature below 0° C., comprising:
(a) providing a cooling subsystem with (i) a startup coolant loop fluidly connected to an electrochemical fuel cell stack and including a startup pump, and (ii) a standard coolant loop including a standard pump and a stack valve for control of coolant such that the standard coolant loop is fluidly connected to the electrochemical fuel cell stack when the stack valve is open and the standard coolant loop is fluidly isolated from the electrochemical fuel cell stack when the stack valve is closed, wherein the coolant volume in the startup coolant loop is less than the coolant volume in the standard coolant loop;
(b) directing coolant from the startup coolant loop through a fuel cell stack having a temperature prior to startup of below 0° C. while isolating coolant from the standard coolant loop from the fuel cell stack; and
(c) when the temperature of either the electrochemical fuel cell stack or the coolant from the startup loop reaches a first predetermined temperature, directing coolant from the standard coolant loop, and optionally coolant from the startup coolant loop, through the fuel cell stack.

33. The method of claim 32, wherein the first predetermined temperature is between 30 and 60° C.

34. The method of claim 32, wherein coolant from the standard coolant loop is introduced at a rate to prevent a temperature gradient greater than 30° C. in the fuel stack.

35. The method of claim 32, wherein coolant from the standard coolant loop is introduced at a rate to prevent a temperature gradient greater than 10° C. in the fuel stack.

36. A method for starting up an electrochemical fuel cell system, comprising:
(a) providing a cooling subsystem with
(i) a startup coolant loop (A) fluidly connected to an electrochemical fuel cell stack and including a startup pump,
(ii) a standard coolant loop (B) including a standard pump and a stack valve such that the standard coolant loop is fluidly connected to the electrochemical fuel cell stack when the stack valve is open and the standard coolant loop is fluidly isolated from the electrochemical fuel cell stack when the stack valve is closed, wherein the coolant volume in the startup coolant loop (A) is less than the coolant volume in the standard coolant loop (B), and
(iii) a heat exchanger coolant loop (C), and
(iv) a heat exchanger (45) in thermal contact with the startup coolant loop (A) and heat exchanger coolant loop (C);
(b) directing coolant from the startup coolant loop (A), and optionally standard coolant loop (B), through a fuel cell stack while isolating coolant from the heat exchanger coolant loop (C) from the fuel cell stack;
(c) when the temperature of either the electrochemical fuel cell stack or the coolant from the startup loop (A) reaches a first predetermined temperature, directing coolant from the standard coolant loop (B) through heat exchanger coolant loop (C) and back to standard coolant loop (B) to increase the temperature in coolant loop (B).

37. The method of claim 36, wherein the temperature of the fuel cell stack prior to startup is below 0° C.

38. The method of claim 36 wherein, in step (c), when the temperature of coolant in coolant loop (B) falls below a predetermined thermal shock value, coolant from standard coolant loop (B) is directed to mix with coolant from the startup loop (A).

39. The method of claim 38, wherein said predetermined thermal shock value is a temperature difference between startup loop (A) and coolant from the standard coolant loop (B) of 30° C.

40. The method of claim 38, wherein said predetermined thermal shock value is a temperature difference between startup loop (A) and coolant from the standard coolant loop (B) of 10° C.
